(19) United States
(12) Patent Application Publication
(10) Pub. No.: US 2013/0051736 A1
(43) Pub. Date: Feb. 28, 2013

(54) CONNECTOR HAVING UNIVERSAL INSERTION SLOT

(71) Applicant: Nai-Chien CHANG, New Taipei City (TW)

(72) Inventor: Nai-Chien CHANG, New Taipei City (TW)

(21) Appl. No.: 13/481,319

(22) Filed: May 25, 2012

(30) Foreign Application Priority Data
Aug. 30, 2011 (TW) 100216142

(51) Int. Cl. G02B 6/42

(52) U.S. Cl. 385/92

(57) ABSTRACT

A connector having a universal insertion slot includes a body and an adapter. The body has an insertion port thereon, and has the insertion slot and an optical component in the body. The adapter has a connection port for connecting with an external transmission line. The adapter connects to the insertion port of the body through a universal end, which has a plurality of insertion terminals and a through hole, the insertion terminals electrically connects with the insertion slot of the body, and the through hole is arranged in a position according to that of the optical component. When the external transmission line connecting with the connection port of the adapter, conductive terminals of the insertion slot electrically connects to terminals of the line via the insertion terminals, and the optical component receives light signal from a fiber line in the line passing through the through hole.

### BACKGROUND OF THE INVENTION

1. Field of the Invention

The present disclosure relates to a connector, especially relates to a connector which the connection interface thereon is changeable depending on user demand.

2. Description of Prior Art

Following the development of electronic industrial, electronic devices are popular now and all around people in day life. Commonly, the electronic devices are usually arranged more than one connector on mainboard for receiving control command to operate, or transmitting data between two electronic devices.

For instance, a popular personal computer mainly has several connectors, such as universal serial bus (USB) connector, external serial advance technology attachment (e-SATA) connector, RJ-45 connector, high definition multimedia interface (HDMI) connector, and etc. Therefore, the personal computer can connect with an external control device via a transmission line, for receiving control command

However, the arrangement space on the mainboard is limited, that is why the amount of the connectors on the mainboard can't be infinite. According to the above issue, there are more stacking connectors published in market. The stacking connector is based on the arrangement space of one traditional connector, and stacks more than one connectors vertically, therefore, the amount and the type of connect is expanded on the mainboard without occupying too much space.

The problem is, the connector types on the stacking connector is fixed after manufacturing completely, there is no way to change the connector type on the stacking connector. If user want to use a transmission interface which is can't be supported by the stacking connector, the mainboard should still arrange a corresponding connector. In this circumstance, the stacking connector is un-useful.

### SUMMARY OF THE INVENTION

The present disclosure is to provide a connector having universal insertion slot thereon, a connection interface of the connector is changeable depending on user demand, and the connection interface is provided for data transmission via traditional transmission lines and[or] fiber lines.

A connector having a universal insertion slot includes a body and an adapter. The body has an insertion port thereon, and has the insertion slot and an optical component in the body. The adapter has a connection port for connecting with an external transmission line. The adapter connects to the insertion port of the body through a universal end, which has a plurality of insertion terminals and a through hole, the insertion terminals electrically connects with the insertion slot of the body, and the through hole is arranged in a position according to that of the optical component. When the external transmission line connecting with the connection port of the adapter, conductive terminals of the insertion slot electrically connects to terminals of the line via the insertion terminals, and the optical component receives light signal from a fiber line in the line passing through the through hole.

Comparing to the prior art, the adapter of the disclosed connector is changeable depending on user demand, and the connector can connect different interface via different adapters. The utility and compatibility of connector is extended. According to the present disclosure, mainboard should set only one connector body, and to connect with many different transmission connectors by changing the adapter thereon.

Also, user requires high data transmission rate this years, so the common transmission interfaces keep changing, the popular transmission interfaces are structured mostly by terminals (e.g. USB), fiber line (e.g. S/PDIF), or integration of terminals and fiber line (e.g. light peak). According to the present disclosure, every kind of the mentioned transmission interfaces are compatible, it is useful in hardware upgrade.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a perspective view of a connector having a universal insertion slot in accordance with a first embodiment.

FIG. 2 is a side view of a connector having a universal insertion slot in accordance with the first embodiment.

FIG. 3 is a schematic view of a connector having a universal insertion slot in accordance with the first embodiment.

FIG. 4 is a side view of a connector having a universal insertion slot in accordance with the first embodiment.

FIG. 5 is a side view of a connector having a universal insertion slot after connection with a first connector in accordance with the first embodiment.

FIG. 6 is a side view of a connector having a universal insertion slot before connection with a second connector in accordance with the first embodiment.

FIG. 7 is a side view of a connector having a universal insertion slot after connection with a second connector in accordance with the first embodiment.

FIG. 8 is a side view of a connector having a universal insertion slot before connection with a third connector in accordance with the first embodiment.

FIG. 9 is a side view of a connector having a universal insertion slot after connection with a third connector in accordance with the first embodiment.

FIG. 10 is a perspective view of a connector having a universal insertion slot in accordance with a second embodiment.

FIG. 11 is a perspective view of a connector having a universal insertion slot in accordance with a third embodiment.

FIG. 12 is a perspective view of a connector having a universal insertion slot in accordance with a forth embodiment.

### DETAILED DESCRIPTION OF THE INVENTION

In cooperation with attached drawings, the technical contents and detailed description of the present invention are described thereinafter according to a preferable embodiment, being not used to limit its executing scope. Any equivalent variation and modification made according to appended claims is all covered by the claims claimed by the present invention.

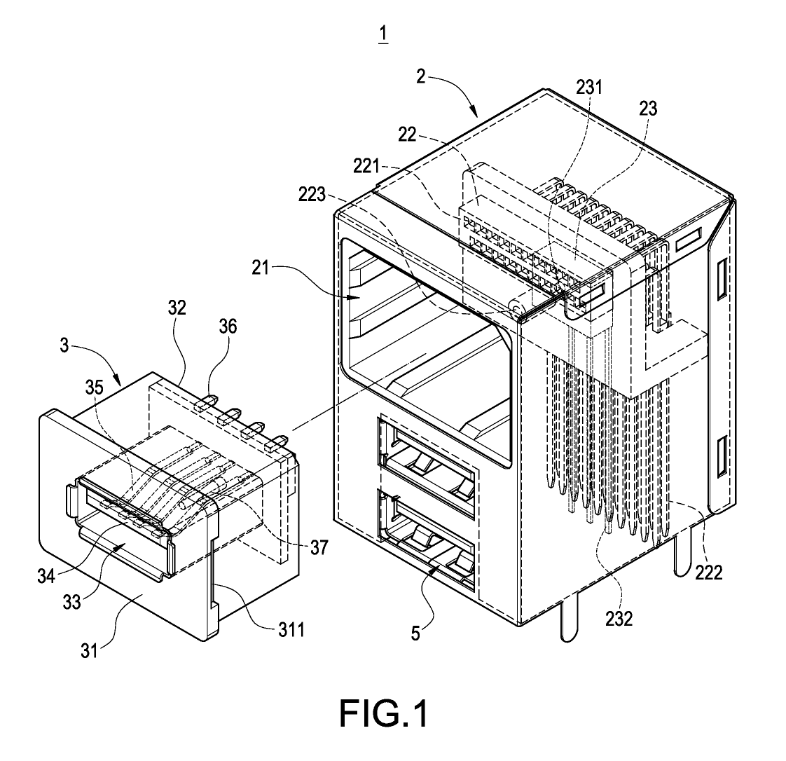

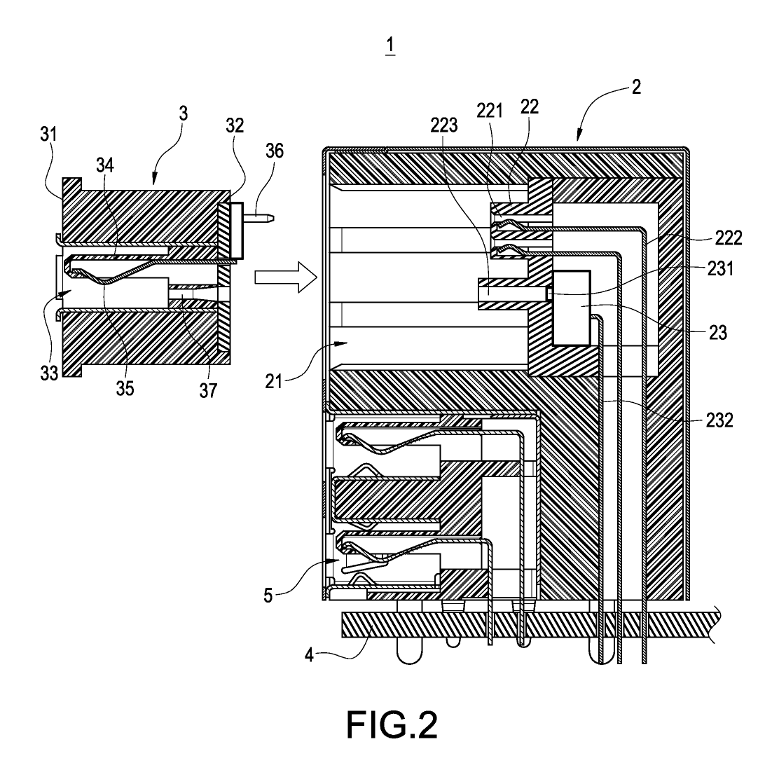

FIG. 1 is a perspective view of a connector having a universal insertion slot in accordance with a first embodiment, and FIG. 2 is a side view of a connector having a universal insertion slot in accordance with the first embodiment. The connector having a universal insertion slot (refers to as the connector 1 hereinafter), mainly includes a body 2 and an adapter 3, the body 2 electrically connects to a mainboard 4 in an external electronic device (not shown), and the adapter 3 is inserted in the body 2. Therefore, the mainboard 4 can be electrically connected to transmission interfaces of different types for data transmission by changing the adapter 3 of the connector 1.

The body 2 mainly has an insertion port 21 at a front end of the body 2, and further has an insertion slot 22 and an optical component 23 therein. The insertion slot 22 has a plurality of insertion holes 221 thereon, and each of the insertion holes 221 has a correspondingly conductive terminal 222 therein. One end of the conductive terminals 222 is arranged in the insertion holes 221 separately, and the other end of the conductive terminals 222 is bended downward and extended out of a bottom of the body 2, so as to electrically connect with the mainboard 4.

The optical component 23 includes a light transceiver 231 and a plurality of welding terminals 232 extending from the light transceiver 231. One end of the welding terminals 232 connects to the light transceiver 231 separately, and the other end of the welding terminals 232 is bended downward and extended out of the bottom of the body 2 with the conductive terminals 222, so as to electrically connect with the mainboard 4. In this embodiment, the conductive terminals 222 pass through the insertion port 21 through the insertion holes 221, and the light transceiver 231 of the optical component 23 also pass through the insertion port 21.

The adapter 3 includes a connection end 31 and a universal end 32 which is away from the connection end 31. The connection end 31 is corresponding to different types of transmission interfaces depending on different adapters 3. The universal end 32 is corresponding to the sharp of the insertion port 21 of the body 2. The adapter 3 has a connection port 33 at the connection end 31, the connection port 33 has a tongue 34 and a plurality of connection terminals 35 therein, and the connection port 33, the tongue 34 and the connection terminals 35 constitute a formal port for connecting with a corresponding interface. In particularly, the tongue 34 is not a necessary component of the port (for example, a RJ-45 port is structured without a tongue therein), it depends on which transmission interface the adapter 3 is supported to, not intended to limit the scope of the present disclosure. Further, the connection end 31 of the adapter 3 has a larger size than the size of the insertion port 21 of the body 2, and the connection end 31 is out of the insertion port 21 during the connection of the adapter 3 and the insertion port 21. The adapter 3 has notches 311 on two sides of the connection end 31, and the notches 311 is used for allowing the adapter 3 to be detached easier from the insertion port 21 of the body 2.

The universal end 32 of the adapter 3 has a plurality of insertion terminals 36, the insertion terminals 36 electrically connect with the connection terminals 35, and the insertion terminals 36 extend out of the adapter 3. Further, the adapter 3 comprises a through slot 37, which is passed through the connection port 33 of the connection end 31 and a surface of the universal end 32.

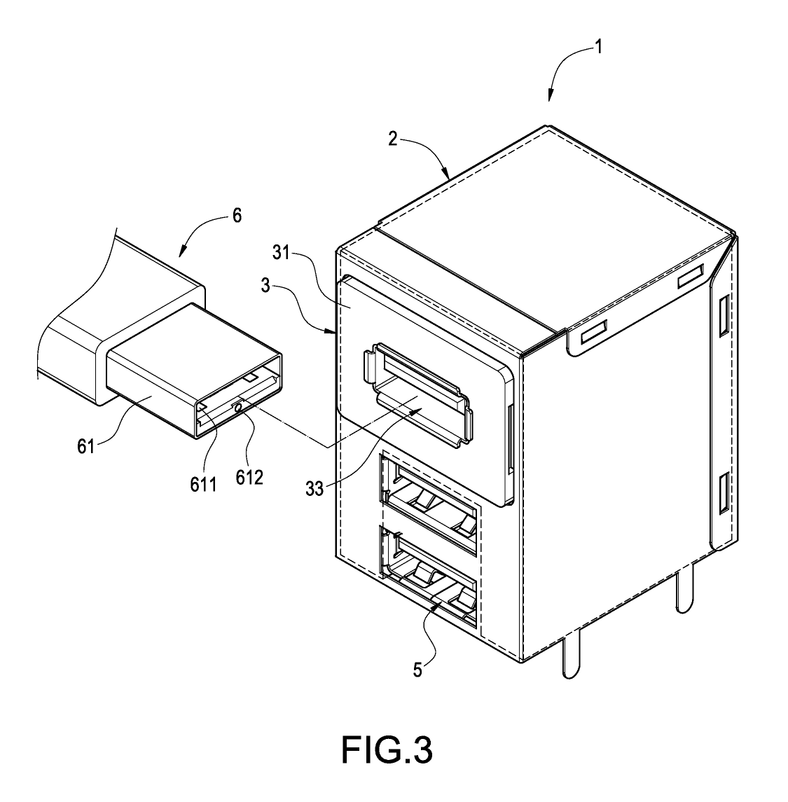

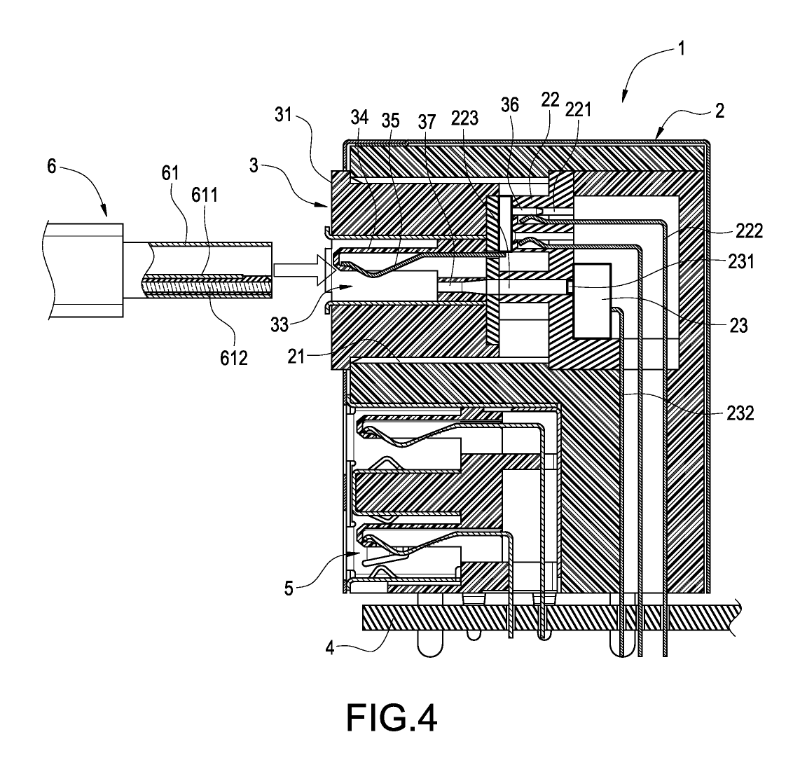

FIG. 3 is a schematic view of a combination of a connector having a universal insertion slot in accordance with the first embodiment, and FIG. 4 is a side view of a connector having a universal insertion slot in accordance with the first embodiment. The adapter 3 inserts into the insertion port 21 of the body 2 through the universal end 32 thereon, and the position of the insertion terminals 36 of the adapter 3 is corresponding to that of the insertion slot 22 of the body 2. Therefore, when the adapter 3 is assembled in the body 2, the insertion terminals 36 are inserted into the insertion holes 221 of the insertion slot 22, so as to electrically connect with the conductive terminals 222 in the insertion slot 22. In particularly, the position of the through slot 37 of the adapter 3 is corresponding to that of the light transceiver 231 of the optical component 23, it is to say that the through slot 37 faces the light transceiver 231 directly when the adapter 3 is assembled in the body 2, and it brings efficiency in light signal transmission.

In this embodiment, the optical component 23 of the body 2 is arranged below the insertion slot 22, the through slot 37 of the adapter 3 is arranged below the insertion terminals 36, and the arranged position of the through slot 37 is corresponding to that of the light transceiver 231 of the optical component 23 mentioned above, but not intended to limit the scope of the present disclosure.

In particularly, the body 2 further comprises a through hole 223, and the position of the through hole 223 is corresponding to the position of the light transceiver 231, and is also corresponding to the position of the through slot 37 of the adapter 3. Therefore, a channel is made for transmitting light signal via the through slot 37 and the through hole 223 when the adapter 3 is assembled in the body 2.

The adapter 3 mainly connects with an external first transmission line 6 via the connection port 33. In this embodiment, the first transmission line 6 has a transmission connector 61, and a plurality of connection terminals 611 and at least one fiber line 612 inside the transmission connector 61. The first transmission line 6 utilizes the connection terminals 611 and the fiber line 612 as data transmission medium at the same time (for example, light peak transmission interface is based on four USB 2.0 terminals and two fiber lines).

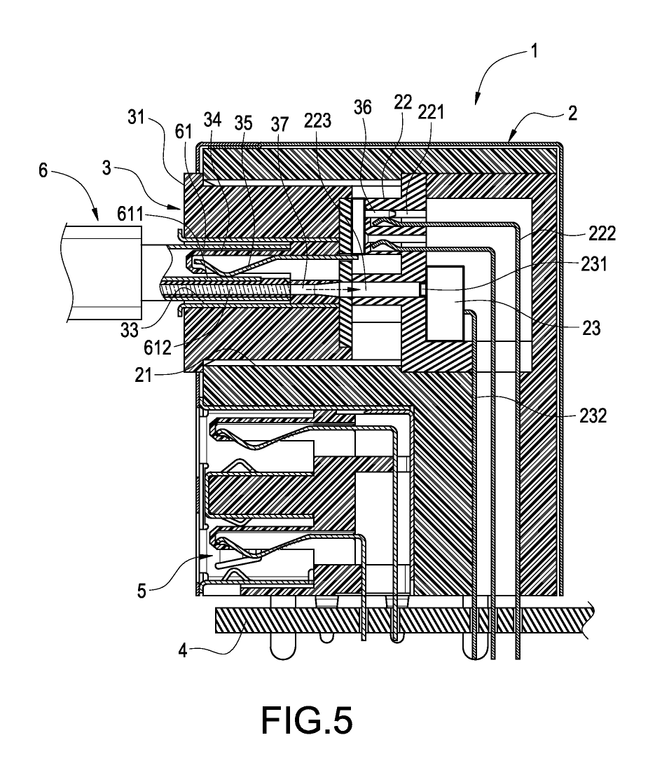

FIG. 5 is a side view of a connector having a universal insertion slot after connection with a first connector in accordance with the first embodiment. When the transmission connector 61 of the first transmission line 6 connects with the connection port 33 of the adapter 3, the connection terminals 611 in the transmission connector 61 can electrically connect with the connection terminals 35 of the adapter 3, so the conductive terminals 222 of the body 2 electrically connect with the connection terminals 611 through the connection terminals 35 of the adapter 3, and executes data transmission of electrical signal.

Further, when the first transmission line 6 connects with the adapter 3, the position of the fiber line 612 in the transmission connector 61 is corresponding to that of the through slot 37 of the adapter 3, so the light transceiver 231 of the optical component 23 can receive light signal from the fiber line 612 through the through slot 37 of the adapter 3 and the through hole 223 of the body 2. The embodiment described above is just one preferred embodiment, the first transmission line 6 can be any transmission interface that includes both the terminals and the fiber line, not intended to limit the scope of the present disclosure.

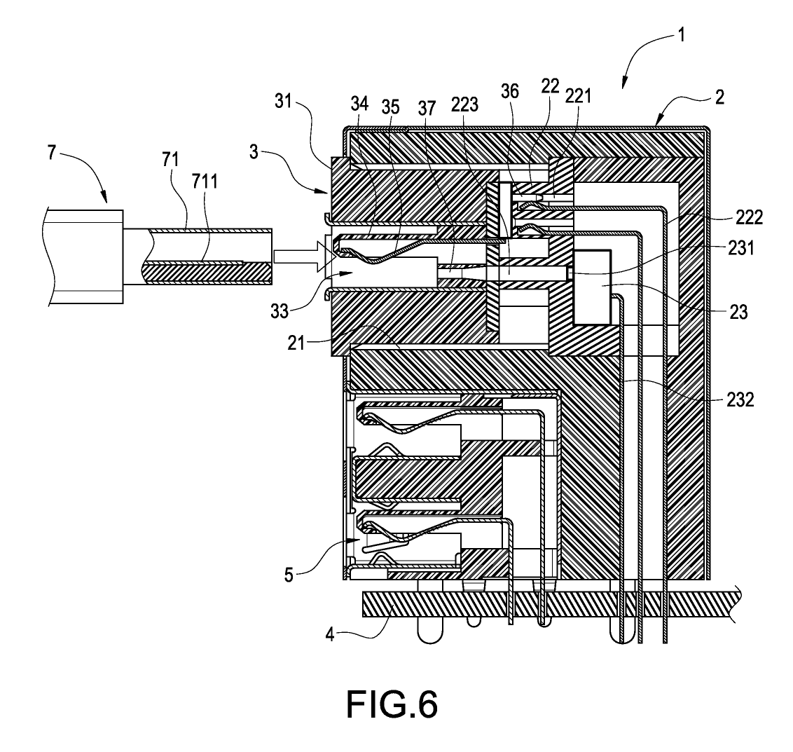

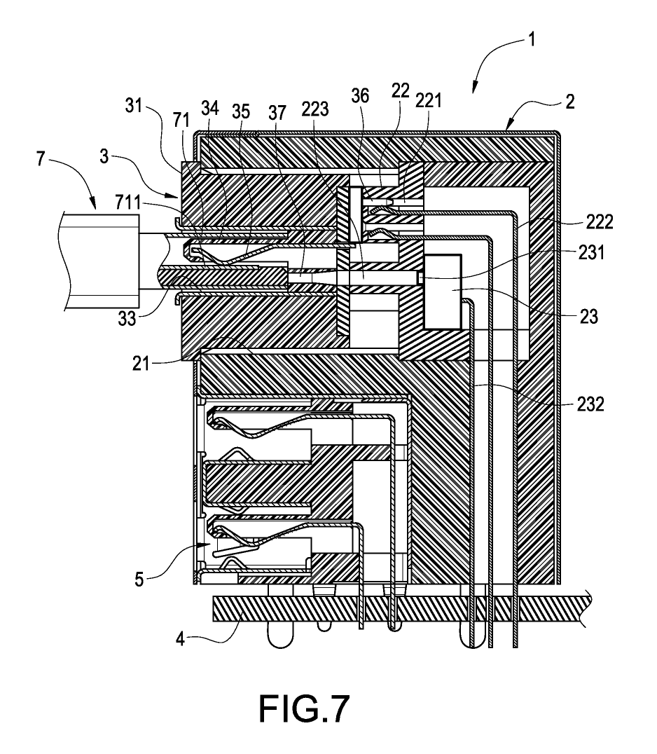

FIG. 6 is a side view of a connector having a universal insertion slot before connection with a second connector in accordance with the first embodiment, and FIG. 7 is a side view of a connector having a universal insertion slot after connection with a second connector in accordance with the first embodiment. In this embodiment, the adapter 3 connects a second transmission line 7 via the connection port 33, the second transmission line 7 has a transmission connector 71, and only has a plurality of connection terminals 711 inside the transmission connector 71. For example, the second transmission line 7 can be implemented by USB interface, external serial advance technology attachment (e-SATA) interface, high definition multimedia interface (HDMI) interface, displayport (DP) interface, and etc.

When the second transmission line 7 connects with the adapter 3, the connection terminals 711 in the transmission connector 71 can electrically connect with the connection terminals 35 of the adapter 3, therefore, the conductive terminals 222 of the body 2 can electrically connect with the connection terminals 711 via the connection terminals 35 of the adapter 3, and executes data transmission of electrical signal. In particularly, the second transmission line 7 in this embodiment do not includes any fiber line, the through slot 37, the through hole 223 and the optical component 23 are not working in this embodiment, but they have no interference with the transmission of electrical signal.

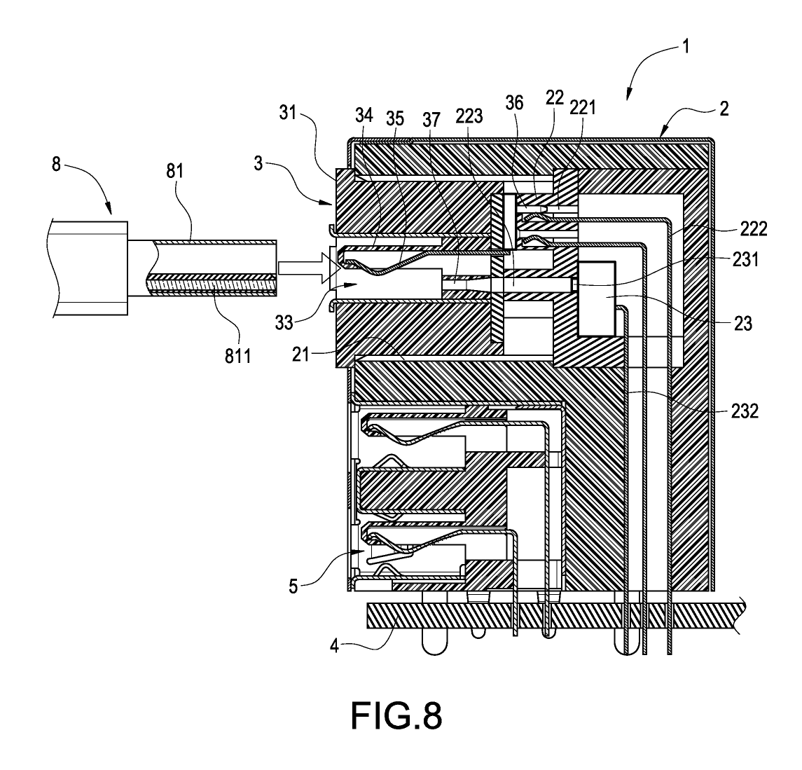

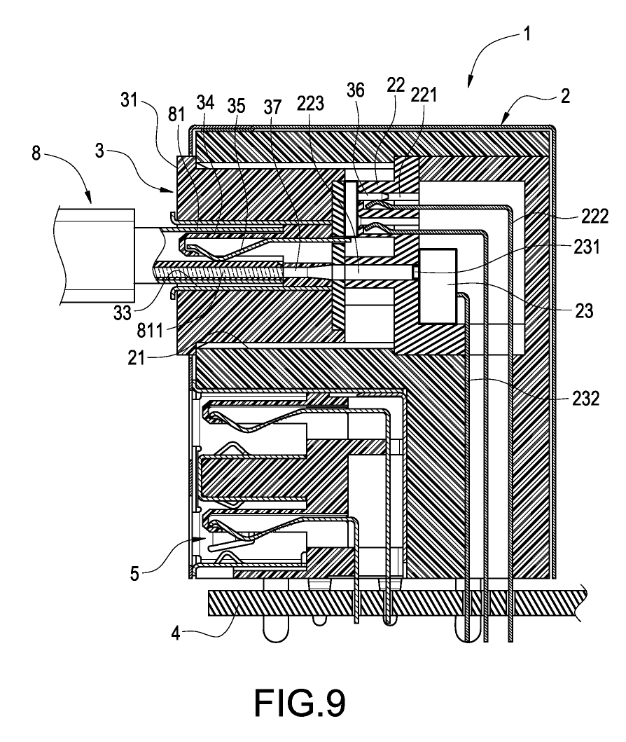

FIG. 8 is a side view of a connector having a universal insertion slot before connection with a third connector in accordance with the first embodiment, and FIG. 9 is a side view of a connector having a universal insertion slot after connection with a third connector in accordance with the first embodiment. In this embodiment, the adapter 3 connects a third transmission line 8 via the connection port 33, the third transmission line 8 has a transmission connector 81, and only has a fiber line 811 inside the transmission connector 81. For example, the third transmission line 8 can be implemented by S/PDIF interface. For another example, the third transmission line 8 can be some kinds of specific interface, which replacing traditional copper wires and terminals with the fiber line 811, such as specific USB, specific e-SATA, specific HDMI, specific displayport, and etc.

When the third transmission line 8 connects with the adapter 3, the fiber line 811 in the transmission connector 81 is arranged in a position which is corresponding to that of the through slot 37 of the adapter 3, therefore, the light transceiver 231 of the optical component 23 can receive light signal from the fiber line 811 through the through slot 37 and the through hole 223 of the body 2. In particularly, the third transmission line 8 in this embodiment do not includes any terminal, the connection terminals 35, the insertion terminals 36 and the conductive terminals 222 are not working in this embodiment, but they have no interference with the transmission of light signal.

The disclosed connector 1 has compatibility in electrical signal transmission with the transmission line via copper wires and terminals, in light signal transmission with the transmission line via fiber line, and also in transmission both electrical signal and light signal with a combination of the two transmission lines. The connection port 33 of the adapter 3 is implemented as USB port or light peak port in advance, for connecting with the transmission line of USB 2.0, USB 3.0, or light peak interface. However, the adapter 3 of the connector 1 in this disclosure is changeable for connecting with different transmission interface.

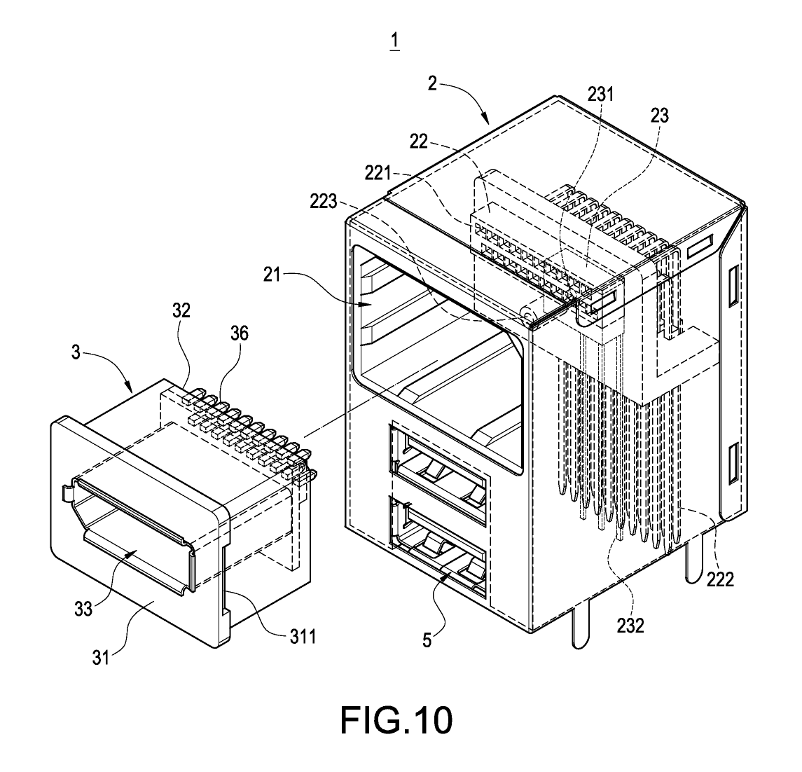

FIG. 10 is a perspective view of a connector having a universal insertion slot in accordance with a second embodiment. In this embodiment, the connection port 33 of the adapter 3 is a displayport (DP), therefore, the connector 1 can connect a displayport transmission line via the connection port 33 of the adapter 3 when the body 2 connects with the adapter 3 in this embodiment.

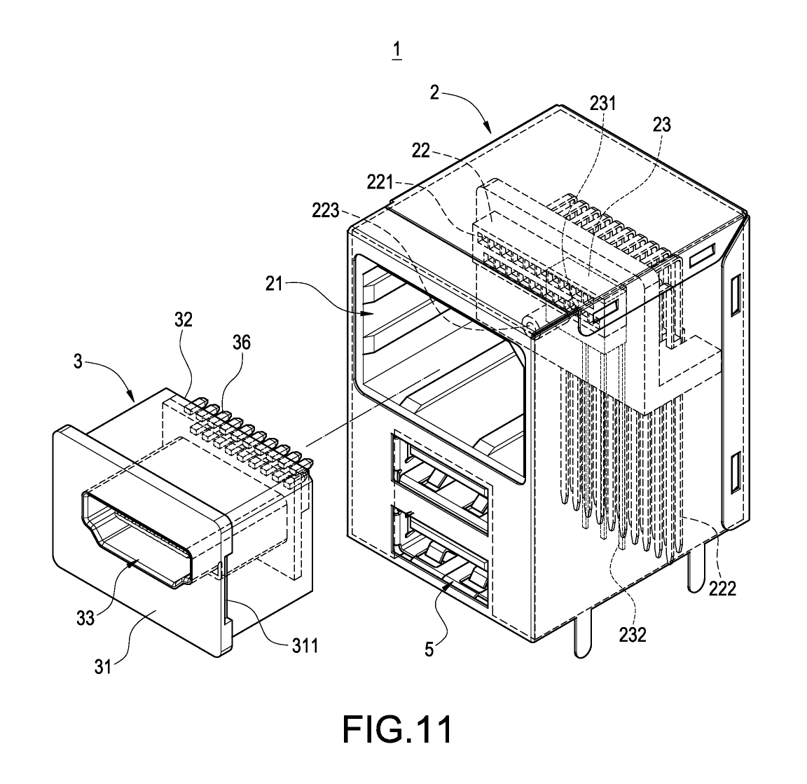

FIG. 11 is a perspective view of a connector having a universal insertion slot in accordance with a third embodiment. In this embodiment, the connector port 33 of the adapter 3 is a HDMI port, therefore, the connector 3 can connect a HDMI transmission line via the connection port 33 of the adapter 3 when the body 2 connects with the adapter 3 in this embodiment.

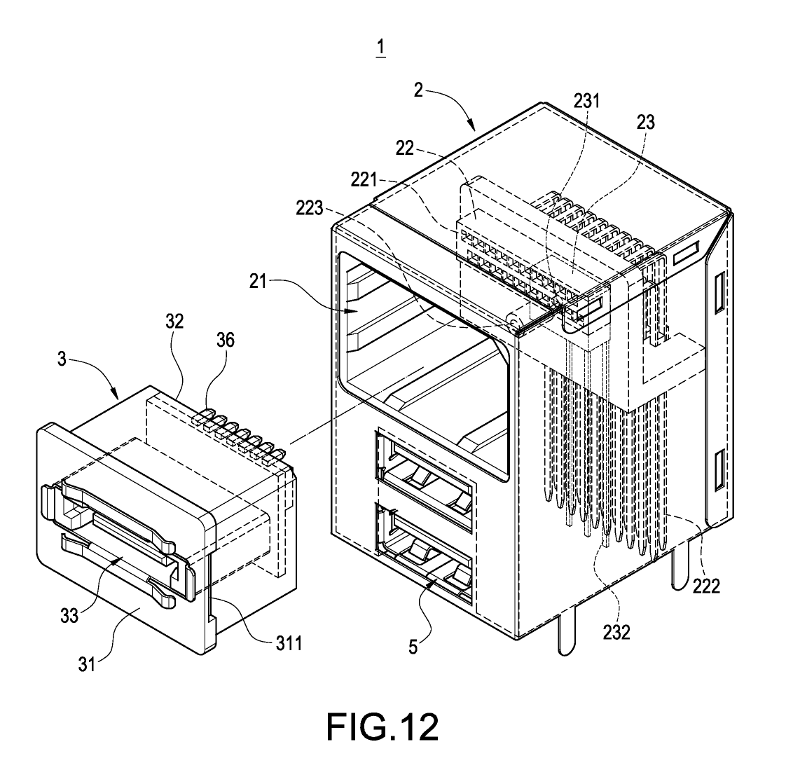

FIG. 12 is a perspective view of a connector having a universal insertion slot in accordance with a forth embodiment. In this embodiment, the connector port 33 of the adapter 3 is an e-SATA port, therefore, the connector 1 can connect an e-SATA transmission line via the connection port 33 of the adapter 3 when the body 2 connects with the adapter 3 in this embodiment.

It should be mentioned is that the body 2 further comprises at least one electronic connector 5 below the insertion port 21, it is to say that the connector 1 can be a stacking connector, and the arrangement space of the mainboard 4 can be saved by using this type of connector 1. The diagram of this embodiment shows that the electronic connectors 5 are USB connectors, however, the electronic connectors 5 can be replaced with e-SATA connector, HDMI connector, displayport connector, or the combination of these connectors, it depends on user demand, not intended to limit the scope of the present disclosure.

Although the present invention has been described with reference to the foregoing preferred embodiments, it will be understood that the invention is not limited to the description thereof. Any equivalent variations and modifications can be made to those skilled in the art in view of the teaching of the present invention are also in the scope of the invention as defined in the appended claims.

What is claimed is:

1. A connector having universal insertion slot, the connector electrically connected with a mainboard in an external electronic device and comprising:
a body having an insertion port at a front end, and having an insertion slot and an optical component therein, the insertion slot having a plurality of insertion holes, each insertion hole having a conductive terminal, the optical component including a light transceiver and a plurality of welding terminals, one end of the conductive terminals and the welding terminals bended downward separately and extended out of the body for electrically connecting with the mainboard; and
an adapter having a connection end and a universal end away from the connection end, the connection end having a connection port, the connection port having a plurality of connection terminals therein, and the universal end having a plurality of insertion terminals electrically connected with the connection terminals, the adapter having a through slot passing through the connection port and surface of the universal end;
wherein, the adapter is configured for assembling in the insertion port of the body, the position of the through slot is according to that of the light transceiver of the optical component, and the insertion terminals insert into the insertion holes of the insertion slot and electrically connect with the conductive terminals separately.

2. The connector having universal insertion slot in claim 1, wherein the optical component of the body is arranged below the insertion slot, and the through slot of the adapter is arranged below the insertion terminals.

3. The connector having universal insertion slot in claim 2, wherein the body further comprises a through hole arranged in a position according to that of the light transceiver and the through slot of the adapter, and the light transceiver receives light signal from a fiber line in an external transmission line through the through slot and the through hole when the external transmission line connecting with the connection port of the adapter.

4. The connector having universal insertion slot in claim 1, wherein the connection end of the adapter has larger size than a size of the insertion port of the body, and the connection end is out of the insertion port during a connection of the adapter and the insertion port.

5. The connector having universal insertion slot of claim 4, wherein the connection end has notches on two side for allowing the adapter to be detached from the insertion port.

6. The connector having universal insertion slot in claim 1, wherein the connection port of the adapter is a universal serial bus (USB) port or a light peak port.

7. The connector having universal insertion slot in claim 1, wherein the connection port of the adapter is a displayport (DP).

8. The connector having universal insertion slot in claim 1, wherein the connection port of the adapter is a high definition multimedia interface (HDMI) port.

9. The connector having universal insertion slot in claim 1, wherein the connection port of the adapter is an external serial advance technology attachment (e-SATA) port.

10. The connector having universal insertion slot in claim 1, wherein the body further comprises at least one electronic connector below the insertion port.

11. The connector having universal insertion slot in claim 10, wherein the electronic connector is selected from a group consisting of USB connector, e-SATA connector, HDMI connector, displayport connector and combination of the connectors.
